(19) United States
(12) Patent Application Publication
(10) Pub. No.: US 2020/0409360 A1
(43) Pub. Date: Dec. 31, 2020

(54) APPARATUS FOR CONTROLLING AUTONOMOUS VEHICLE

(71) Applicant: HYUNDAI MOBIS Co., Ltd., Seoul (KR)

(72) Inventor: Woo Hyun HWANG, Yongin-si (KR)

(21) Appl. No.: 16/899,993

(22) Filed: Jun. 12, 2020

(30) Foreign Application Priority Data
Jun. 27, 2019 (KR) 10-2019-0076792

(51) Int. Cl. G05D 1/00; H04L 12/40; B60W 50/023

(52) U.S. Cl. CPC G05D 1/0077; H04L 12/40; B60W 2050/0292; H04L 2012/40215; B60W 50/023

(57) ABSTRACT

An apparatus for controlling an autonomous vehicle includes first and second autonomous controllers, first and second brake modules, and first and second communication networks. The first autonomous controller controls autonomous driving. The second autonomous controller controls autonomous driving in a backup situation. The first brake module receives a first deceleration command from the first autonomous controller to operate a brake. The second brake module receives a second deceleration command from the second autonomous controller to operate the brake. The first communication network allows monitoring information to be exchanged between the first and second brake modules, and transmits the first and second deceleration commands from the first and second autonomous controllers through a first gateway to the first and second brake modules. The second communication network transmits the first and second deceleration commands from the first and second autonomous controllers through a second gateway to the first and second brake modules.

### CROSS-REFERENCE TO RELATED APPLICATION

This application claims priority to and the benefit of Korean Patent Application No. 10-2019-0076792, filed Jun. 27, 2019, which is hereby incorporated by reference for all purposes as if fully set forth herein.

### BACKGROUND

### Field

Exemplary embodiments generally relate to an apparatus for controlling an autonomous vehicle, and more particularly, to an apparatus for controlling an autonomous vehicle that is capable of not only coping with a backup situation by dual autonomous controllers by monitoring operation states of dual brake modules through a first communication network in an autonomous vehicle, but also transmitting and receiving operation states and control commands between the respective brake modules and the respective autonomous controllers through a second communication network in response to an abnormality of (or in) the first communication network.

### Discussion

In general, autonomous devices, which are built in various driving means to perform autonomous driving through driving location search, are mainly applied to ships, aircraft, etc. Autonomous devices have also been applied to vehicles traveling on the road to, for instance, notify a user through a monitor of various types of information, such as driving routes and road congestion, or to drive vehicles or control driving conditions for themselves.

Autonomous driving is a strategic technology for the era of smart vehicles, and the level of autonomy is classified according to the degree of driver interference in driving control. For example, the National Highway Traffic Safety Administration (NHTSA) classifies the autonomous driving into a plurality of automation levels according to the degree of driver interference, and unmanned vehicles excluding driver interference are ultimately sought. Among the automation levels, level 4 (e.g., a “mind off” mode) is capable of supporting autonomous driving without human intervention, except for in limited spatial areas (e.g., a specific road or zone) or under special circumstances. In other words, level 4 autonomy may be referred to as a “high automation” level. Level 5 (e.g., a “steering wheel optional” scenario) is fully capable of autonomous driving without restriction on roads, zones, or circumstances, and, as such, may be considered a “full automation” level.

In level 4 or 5 autonomy, since a driver completely transfers the driving control of an autonomous vehicle to the autonomous vehicle itself, it can be difficult for the driver to intervene when an emergency occurs in association with, for example, a brake module, an autonomous controller, and/or a (e.g., an entire) communication network of the vehicle such that the system of the autonomous vehicle copes with the situation itself. Accordingly, in the case of automation level 4 or 5, there is a need to secure redundancy for a braking system, an autonomous controller, and/or a (e.g., an entire) communication network of the vehicle to ensure the reliability of the system.

Related art is disclosed in Korean Patent Application Publication No. 10-2011-0059488, published Jun. 2, 2011, and entitled “System and Method for Controlling Power of Vehicle.”

The above information disclosed in this section is only for understanding the background of the inventive concepts, and, therefore, may contain information that does not form prior art.

### SUMMARY

Some aspects provide an apparatus for controlling an autonomous vehicle, which is capable of not only responding to a backup situation by dual autonomous controllers by monitoring operation states of dual brake modules through a first communication network in an autonomous vehicle, but also transmitting and receiving operation states and control commands between the respective brake modules and the respective autonomous controllers through a second communication network in response to an abnormality of (or in) the first communication network.

Additional aspects will be set forth in the detailed description which follows, and, in part, will be apparent from the disclosure, or may be learned by practice of the inventive concepts.

According to some aspects, an apparatus for controlling an autonomous vehicle includes a first autonomous controller, a second autonomous controller, a first brake module, a second brake module, a first communication network, and a second communication network. The first autonomous controller is configured to control autonomous driving. The second autonomous controller configured to control autonomous driving in a backup situation. The first brake module is configured to receive a first deceleration command from the first autonomous controller to operate a brake. The second brake module is configured to receive a second deceleration command from the second autonomous controller to operate the brake. The first communication network is configured to allow monitoring information to be exchanged between the first and second brake modules, and to transmit the first and second deceleration commands from the first and second autonomous controllers through a first gateway to the first and second brake modules. The second communication network is configured to transmit the first and second deceleration commands from the first and second autonomous controllers through a second gateway to the first and second brake modules.

In an embodiment, the first and second autonomous controllers may be configured to transmit the first and second deceleration commands through the first communication network in response to normal operation of the first communication network, and the first and second autonomous controllers may be configured to transmit the first and second deceleration commands through the second communication network in response to abnormal operation of the first communication network.

In an embodiment, the first brake module may include a first braking actuator and a first brake controller. The first braking actuator may be configured to drive the brake. The first brake controller may be configured to operate the first braking actuator in response to the first deceleration command.

In an embodiment, the second brake module may include a second braking actuator and a second brake controller. The second braking actuator may be configured to drive the brake. The second brake controller may be configured to operate the second braking actuator in response to the second deceleration command.

In an embodiment, the first and second communication networks may be interconnected through a controller area network (CAN).

In an embodiment, the first and second brake modules may be configured to exchange at least one of a control state and state information of a braking actuator, an operation state, and failure information with each other through the first communication network.

In an embodiment, the first brake module may include a first steering controller configured to operate a first steering actuator for driving a steering device. The first steering controller may be configured to receive a first steering command from the first autonomous controller to operate the first steering actuator.

In an embodiment, the first steering controller may be directly connected to the first steering actuator.

In an embodiment, the second brake module may include a second steering controller configured to operate a second steering actuator for driving the steering device. The second steering controller may be configured to receive a second steering command from the second autonomous controller to operate the second steering actuator.

In an embodiment, the second steering controller may be directly connected to the second steering actuator.

In an embodiment, the first steering controller may be directly connected to the first steering actuator, and the second steering controller may be directly connected to the second steering actuator.

In an embodiment, the first and second autonomous controllers may be configured to transmit the first and second steering commands through the first communication network in response to normal operation of the first communication network, and the first and second autonomous controllers may be configured to transmit the first and second steering commands through the second communication network in response to abnormal operation of the first communication network.

According to various exemplary embodiments, an apparatus for controlling an autonomous vehicle can not only respond to a backup situation by dual autonomous controllers by monitoring operation states of dual brake modules through a first communication network in the autonomous vehicle, but also can transmit and receive the operation states and the control commands between the respective brake modules and the respective autonomous controllers through a second communication network in response to an abnormality of (or in) the first communication network. Therefore, it is possible to perform fully autonomous driving even in the event of a communication failure. In addition, since the dual brake modules may include respective steering controllers to operate steering actuators, it is possible to not only reduce the network, but also increase the ease of mounting the steering modules.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a block diagram illustrating an apparatus for controlling an autonomous vehicle according to some exemplary embodiments.

FIG. 2 is a table for explaining an operation situation in a normal state by the apparatus for controlling an autonomous vehicle of FIG. 1 according to some exemplary embodiments.

FIG. 3 is a table for explaining an operation situation in an abnormal communication state by the apparatus for controlling an autonomous vehicle of FIG. 1 according to some exemplary embodiments.

### DETAILED DESCRIPTION OF SOME EXEMPLARY EMBODIMENTS

In the following description, for the purposes of explanation, numerous specific details are set forth in order to provide a thorough understanding of various exemplary embodiments. As used herein, the terms “embodiments” and “implementations” are used interchangeably and are non-limiting examples employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some exemplary embodiments. Therefore, unless otherwise specified, the features, components, modules, layers, films, panels, regions, aspects, etc. (hereinafter individually or collectively referred to as an “element” or “elements”), of the various illustrations may be otherwise combined, separated, interchanged, and/or rearranged without departing from the inventive concepts.

The use of cross-hatching, shading, and/or line thickness in the accompanying drawings is generally provided to clarify boundaries between adjacent elements. As such, neither the presence nor the absence of cross-hatching, shading, and/or line thicknesses indicates any preference or requirement for particular materials, material properties, dimensions, proportions, commonalities between illustrated elements, and/or any other characteristic, attribute, property, etc., of the elements, unless specified. Also, in the accompanying drawings, the size and relative sizes of elements may be exaggerated for clarity and/or descriptive purposes. As such, the sizes and relative sizes of the respective elements are not necessarily limited to the sizes and relative sizes shown in the drawings. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. Other terms and/or phrases used to describe a relationship between elements should be interpreted in a like fashion, e.g., “between” versus “directly between,” “adjacent” versus “directly adjacent,” “on” versus “directly on,” etc. Further, the term “connected” may refer to physical, electrical, and/or fluid connection. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments may be described herein with reference to sectional views, isometric views, perspective views, plan views, and/or exploded depictions that are schematic illustrations of idealized exemplary embodiments and/or intermediate structures. As such, variations from the shapes of the illustrations as a result of, for example, manufacturing techniques and/or tolerances, are to be expected. Thus, exemplary embodiments disclosed herein should not be construed as limited to the particular illustrated shapes of regions, but are to include deviations in shapes that result from, for instance, manufacturing. To this end, regions illustrated in the drawings may be schematic in nature and shapes of these regions may not reflect the actual shapes of regions of a device, and, as such, are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the inventive concepts. Further, the blocks, units, and/or modules of some exemplary embodiments may be physically combined into more complex blocks, units, and/or modules without departing from the inventive concepts.

Hereinafter, various exemplary embodiments of an apparatus for controlling an autonomous vehicle will be described with reference to the accompanying drawings

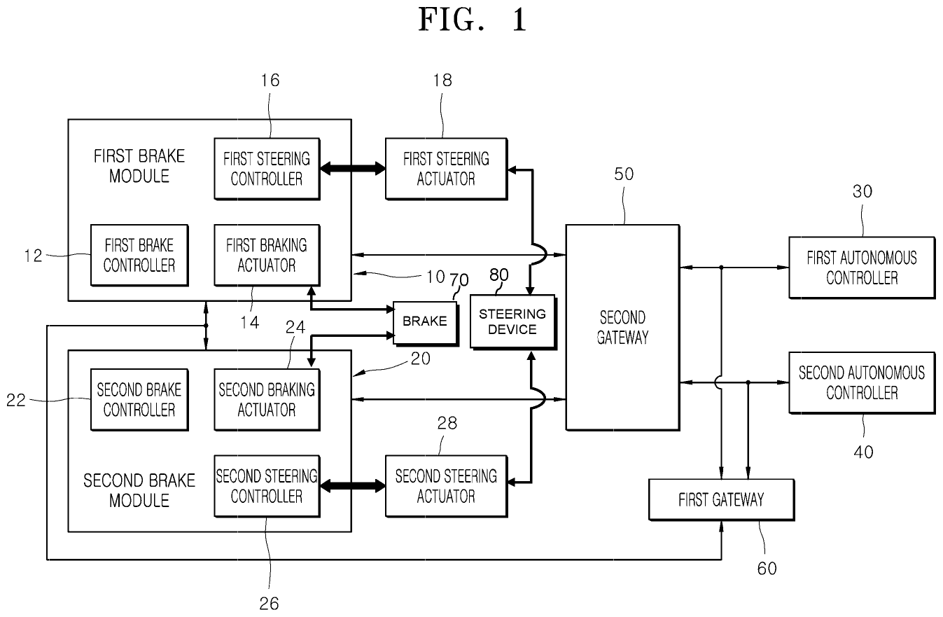

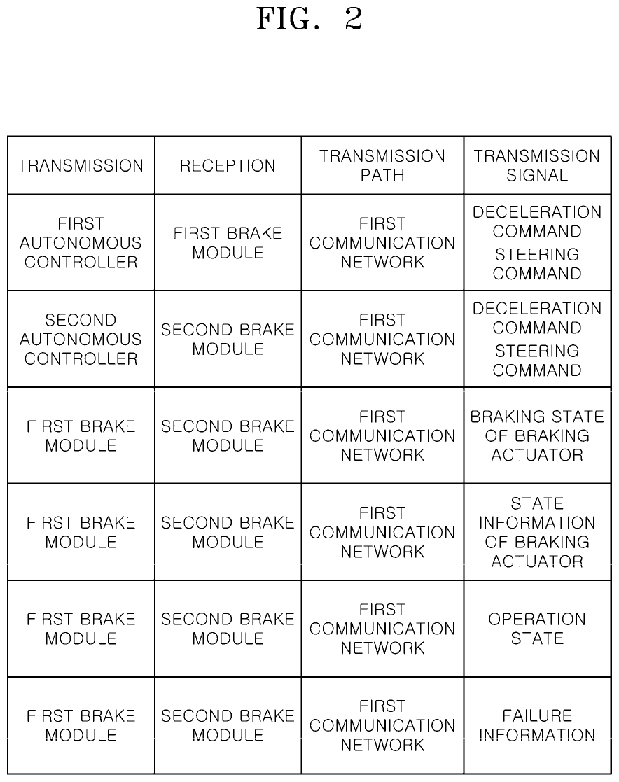

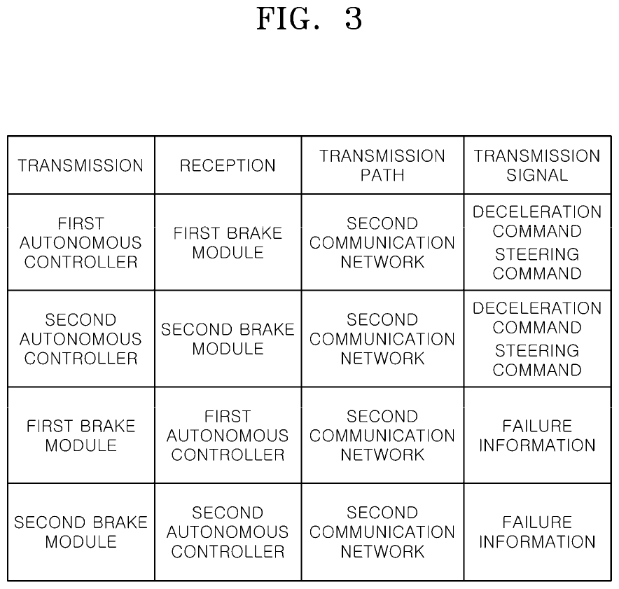

FIG. 1 is a block diagram illustrating an apparatus for controlling an autonomous vehicle according to some exemplary embodiments. FIG. 2 is a table for explaining an operation situation in a normal state by the apparatus for controlling an autonomous vehicle of FIG. 1 according to some exemplary embodiments. FIG. 3 is a table for explaining an operation situation in an abnormal communication state by the apparatus for controlling an autonomous vehicle of FIG. 1 according to some exemplary embodiments.

As illustrated in FIG. 1, an apparatus for controlling an autonomous vehicle according to some exemplary embodiments may include a first autonomous controller 30, a second autonomous controller 40, a first brake module 10, a second brake module 20, a first communication network, and a second communication network.

The first autonomous controller 30 may output a control command for a vehicle to autonomously travel through acceleration, deceleration, steering, and braking after determining a surrounding situation of the vehicle through, for instance, one or more sensors, e.g., at least one of radar, light detection and ranging (LiDAR), camera, etc.

The first autonomous controller 30 may output at least one of a deceleration command and a steering command to the first brake module 10. The second autonomous controller 40 may output at least one of a deceleration command and a steering command to the second brake module 20 while acting as the first autonomous controller 30 in a backup situation for fully autonomous driving at automation level 4 or 5.

The first brake module 10 may receive the deceleration command from the first autonomous controller 30 to operate a brake 70. The first brake module 10 may include a first braking actuator 14 for driving the brake 70 and a first brake controller 12 for operating the first braking actuator 14 in response to the deceleration command.

The second brake module 20 may receive the deceleration command from the second autonomous controller 40 to operate the brake 70 in a backup situation. The second brake module 20 may include a second braking actuator 24 for driving the brake 70 and a second brake controller 22 for operating the second braking actuator 24 in response to the deceleration command.

According to various exemplary embodiments, the first and second brake modules 10 and 20 may mutually monitor whether a failure occurs while exchanging control states, state information, and/or failure information with each other.

The first communication network may allow monitoring information to be exchanged between the first and second brake modules 10 and 20, and may transmit the deceleration commands from the first and second autonomous controllers 30 and 40 through a first gateway 60 to the first and second brake modules 10 and 20. The first and second brake modules 10 and 20 may exchange one or more of the control state and state information of the braking actuator, an operation state, and/or failure information through the first communication network.

The second communication network may transmit the deceleration commands from the first and second autonomous controllers 30 and 40 through a second gateway 50 to the first and second brake modules 10 and 20. In addition, values measured from in-vehicle sensors may also be transmitted through the second communication network.

In various exemplary embodiments, the first and second autonomous controllers 30 and 40 may transmit the deceleration commands through the first communication network when communication is normal, and through the second communication network in response to communication via the first communication network being abnormal, e.g., in response to a soft or hard failure associated with the first communication network.

The first and second communication networks may be interconnected through a controller area network (CAN).

In some exemplary embodiments, the first brake module 10 may further include a first steering controller 16 configured to operate a first steering actuator 18 for driving a steering device. As such, the first steering controller 16 may receive a steering command from the first autonomous controller 30 to operate the first steering actuator 18. The first steering controller 16 may be directly connected to the first steering actuator 18 to operate the first steering actuator 18 so that it is possible to reduce the network, e.g., size and/or complexity of the network. In addition, since the first steering controller 16 may be provided in the first brake module 10, it is possible to increase the ease of mounting.

Similar to the first brake module 10, the second brake module 20 may further include a second steering controller 26 configured to operate a second steering actuator 28 for driving the steering device. In a backup situation, the second steering controller 26 may receive a steering command from the second autonomous controller 40 to operate the second steering actuator 28. The second steering controller 26 may be directly connected to the second steering actuator 28 to operate the second steering actuator 28 so that it is possible to reduce the network. In addition, since the second steering controller 26 may be provided in the second brake module 20, it is possible to increase the ease of mounting.

When the first and second brake modules 10 and 20 include the first and second steering controllers 16 and 26, respectively, the first and second autonomous controllers 30 and 40 may transmit the steering commands through the first communication network when communication is normal, and through the second communication network when communication is abnormal.

The operation situation of the apparatus for controlling an autonomous vehicle having the above-mentioned configuration will now be described in more detail. In a normal state, the apparatus may be operated such that the first autonomous controller 30 transmits the deceleration command to the first brake module 10 through the first gateway 60 as the first communication network as illustrated in FIG. 2.

The second autonomous controller 40 may transmit the deceleration command to the second brake module 20 through the first gateway 60. In addition, the first and second brake modules 10 and 20 may exchange control state and state information of a braking actuator, an operation state, and/or failure information with each other for mutual monitoring through the first communication network.

In an operation situation in which communication is abnormal, as illustrated in FIG. 3, the first autonomous controller 30 may transmit the deceleration command to the first brake module 10 through the second gateway 50 as the second communication network, and the second autonomous controller 40 may transmit the deceleration command to the second brake module 20 through the second gateway 50.

The first brake module 10 may transmit the failure information to the first autonomous controller 30 through the second gateway 50, and the second brake module 20 may transmit the failure information to the second autonomous controller 40 through the second gateway 50. As such, failure information can be transmitted to each of the first and second autonomous controllers 30 and 40 through the second communication network even in an abnormal communication state. Therefore, the first and second autonomous controllers 30 and 40 enable autonomous driving to be performed by determining the initiative depending on the failure state.

According to various exemplary embodiments, an apparatus for controlling an autonomous vehicle can not only respond to a backup situation by dual autonomous controllers by monitoring operation states of dual brake modules through a first communication network in the autonomous vehicle, but can also transmit and receive the operation states and the control commands between the respective brake modules and the respective autonomous controllers through a second communication network in response to the first communication network functionally abnormally. Therefore, it is possible to perform fully autonomous driving even in the event of a communication failure, e.g., a hard failure or a soft failure. In addition, since the dual brake modules may include respective steering controllers to operate steering actuators, it is possible to not only reduce the network, but also increase the ease of mounting the steering modules.

Although certain exemplary embodiments and implementations have been described herein, other embodiments and modifications will be apparent from this description. Accordingly, the inventive concepts are not limited to such embodiments, but rather to the broader scope of the accompanying claims and various obvious modifications and equivalent arrangements as would be apparent to one of ordinary skill in the art.

What is claimed is:

1. An apparatus for controlling an autonomous vehicle, the apparatus comprising:
a first autonomous controller configured to control autonomous driving;
a second autonomous controller configured to control autonomous driving in a backup situation;
a first brake module configured to receive a first deceleration command from the first autonomous controller to operate a brake;
a second brake module configured to receive a second deceleration command from the second autonomous controller to operate the brake;
a first communication network configured to allow monitoring information to be exchanged between the first and second brake modules, and to transmit the first and second deceleration commands from the first and second autonomous controllers through a first gateway to the first and second brake modules; and
a second communication network configured to transmit the first and second deceleration commands from the first and second autonomous controllers through a second gateway to the first and second brake modules.

2. The apparatus of claim 1, wherein:
the first and second autonomous controllers are configured to transmit the first and second deceleration commands through the first communication network in response to normal operation of the first communication network; and
the first and second autonomous controllers are configured to transmit the first and second deceleration commands through the second communication network in response to abnormal operation of the first communication network.

3. The apparatus of claim 1, wherein the first brake module comprises:
a first braking actuator configured to drive the brake; and
a first brake controller configured to operate the first braking actuator in response to the first deceleration command.

4. The apparatus of claim 3, wherein the second brake module comprises:
a second braking actuator configured to drive the brake; and
a second brake controller configured to operate the second braking actuator in response to the second deceleration command.

5. The apparatus of claim 1, wherein the first and second communication networks are interconnected through a controller area network (CAN).

6. The apparatus of claim 1, wherein the first and second brake modules are configured to exchange at least one of a control state and state information of a braking actuator, an operation state, and failure information with each other through the first communication network.

7. The apparatus of claim 1, wherein:
the first brake module comprises a first steering controller configured to operate a first steering actuator for driving a steering device; and
the first steering controller is configured to receive a first steering command from the first autonomous controller to operate the first steering actuator.

8. The apparatus of claim 7, wherein the first steering controller is directly connected to the first steering actuator.

9. The apparatus of claim 7, wherein:
the second brake module comprises a second steering controller configured to operate a second steering actuator for driving the steering device; and
the second steering controller is configured to receive a second steering command from the second autonomous controller to operate the second steering actuator.

10. The apparatus of claim 9, wherein the second steering controller is directly connected to the second steering actuator.

11. The apparatus of claim 9, wherein:
the first steering controller is directly connected to the first steering actuator; and
the second steering controller is directly connected to the second steering actuator.

12. The apparatus according to claim 9, wherein:
the first and second autonomous controllers are configured to transmit the first and second steering commands through the first communication network in response to normal operation of the first communication network; and
the first and second autonomous controllers are configured to transmit the first and second steering commands through the second communication network in response to abnormal operation of the first communication network.
